(19) United States
(12) Patent Application Publication
(10) Pub. No.: US 2008/0214399 A1
(43) Pub. Date: Sep. 4, 2008

(54) Enhanced amino acid formulations

(76) Inventors: Benjamin Belkind, Wilmette, IL (US); Franklin Paul Silverman, Highland Park, IL (US); Peter D. Petracek, Grayslake, IL (US); Prem Warrior, Green Oaks, IL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/982,688

(22) Filed: Nov. 2, 2007

Related U.S. Application Data
(60) Provisional application No. 60/856,445, filed on Nov. 3, 2006.

(51) Int. Cl. A01N 37/06; A01P 21/00

(52) U.S. Cl. 504/320

(57) ABSTRACT

Formulations comprising non-protein amino acids such as aminoethoxyvinylglycine (AVG) and selected hydrophobic agents have improved agrochemical performance.

### BACKGROUND OF THE INVENTION

Plant growth and development is controlled by environmental, physiological, and molecular factors. Plant hormones are a means of physiological control and comprise several classes of small molecules. One plant hormone, ethylene, is involved in control of dormancy, flowering, maturation of fruits, senescence and other processes. Ethylene and ethylene-producing chemicals are used commercially to stimulate flowering of pineapple, synchronize boll opening of cotton, enhance color of fruit crops, and promote defoliation.

Inhibition of ethylene biosynthesis and perception are attractive targets for agrochemical development. Silver salts are used to block ethylene perception and enhance the vase life of cut flowers and promote gynoecious flowers in cucurbits. 1-Methylcyclopropene (1-MCP) is used to enhance the postharvest storage of apples and other produce. Aminoethoxyvinylglycine (AVG) is a non-protein amino acid that is a competitive inhibitor of the rate-limiting step in ethylene biosynthesis. AVG is used to slow down fruit maturation and prevent premature fruit drop and promote fruit set in walnut and other crops (Dekazos, 1979, Proc. Fla. State Hort. Soc., 92:248-252; Natti, J. Amer. Soc. Hort. Sci., 103: 834-836; Bangerth, 1979, J. Amer. Soc. Hort. Sci., 103: 401-406).

For a foliar applied chemical, the rate of uptake depends on many factors including plant organ, species, and age, environmental conditions including temperature and humidity, method of application and composition of the applied solution. AVG is a highly hydrophilic molecule, with a solubility approaching 93 grams/100 mL water at 24° C. Conversely, the plant cuticle is a lipophilic membrane that covers the aerial parts of all terrestrial plants (Bukovac, M. J., 2005, Periodicum Biologorum, 107: 1-9; Bukovac, M. J. 2005, HortTechnology, 15: 222-231). The cuticle is the primary barrier to the penetration of foliar applied chemicals. Thus, it is an object of the present invention to increase AVG uptake and thus performance.

It is a further object of the present invention to increase the performance of AVG though complexation with agents, which in turn affect the hydrophilic/hydrophobic character of the active ingredient.

It is also an object of this invention to disclose a method for the reducing ethylene production in crops, as well as to describe a method for the preparation of polarity-modified AVG formulations.

It is also an object of the present invention to formulate AVG to allow lower use rates.

### SUMMARY OF THE INVENTION

The present invention is directed to a formulation comprising AVG and at least one hydrophobic agent. Such agent, in combination with AVG, improves agrochemical performance. In particular, plant growth regulator formulations comprising AVG in combination with lipophilic alpha-amino acids or other hydrophobic agents are shown to increase ethylene suppression by AVG.

More particularly, the present invention is directed to, a plant growth regulating composition or formulation comprising from 0.001 to 99.999 molar % AVG, and from 0.001 to 99.999 molar % of the hydrophobic agent. Preferably the composition of the present invention comprises from 0.1 to 99.9 molar % AVG and from 0.1 to 99.9 molar % of the hydrophobic agent. Optionally an inert solvent or solid diluent may be added to the composition prior to use in an amount not to exceed 99.9% by weight of the total formulation.

The present invention is further directed to a method of inhibiting ethylene in a crop plant by adding to aminoethoxyvinylglycine an effective amount of a hydrophobic amino acid and applying an effective amount of the combination to the plant.

### DETAILED DESCRIPTION OF THE INVENTION

As used herein, a “formulation” is defined as any chemical composition, and/or physical form, of an active ingredient or ingredients, aimed at facilitating the end-use application, physical properties, and/or efficacy, of the active ingredient or ingredients.

In addition to AVG, other non-protein amino acids may be utilized in the compositions and methods of the present invention. As used herein, “amino acid” is defined as any substituted or un-substituted alpha amino acid. A non-protein amino acid is an amino acid that is made in a plant or micro-organism, but is not incorporated into proteins. More than 100 non-protein amino acids have been isolated from plants (Rosenthal, 1982, Plant Nonprotein Amino Acids, Academic Press). Examples of non-protein amino acids include AVG, 3-cyanoalanine and mimosine.

A hydrophobic amino acid is defined as an amino acid which has a hydrophobic side chain. Presently preferred hydrophobic amino acids are phenylalanine, tyrosine, tryptophan, lysine, arginine, methionine, leucine and isoleucine.

Representative hydrophobic modifying agents may be selected from groups such as substituted or unsubstituted alkyl carboxylates, substituted or unsubstituted alkylaryl carboxylates, amphipathic molecules such as substituted or unsubstituted mono- or di-alkyl phosphates, substituted or unsubstituted alkyl sulfates sulfites or sulfonates, phospholipids such as lecithin and/or substituted or unsubstituted mono-, di-, or tri-alkyl amines.

The compositions of the present invention may be formulated as powdered or granulated solids, or aqueous concentrates which are sufficiently storage stable for commercial use and which are diluted with water before use. Such concentrates have a concentration of from 100% to 0.01% of the compositions of the present invention, preferably 50% to 0.1% and most preferably 30% to 1%.

The compositions of the present invention are powdered or granulated, or dispersed or dissolved in water to a concentration of from 15% to 0.0015%, preferably 5.0% to 0.002% and most preferably 1.6% to 0.05% for application.

Any such formulation may also contain other active ingredients, singly or in combination with other inert ingredients, designed and incorporated to affect desirable physical and or chemical behavior of the end use formulation. Thus, such formulations may also contain, wetting agents, dispersants, emulsifiers, binders, humectants, UV stabilizers, antioxidants, preservatives, thickening, suspending agents, viscosity modifying agents, or other fillers.

In another embodiment of the present invention, AVG may be formulated as a concentrate and the hydrophobic agent may be formulated as a concentrate. The two concentrates are then mixed and diluted prior to use.

Any such concentrate may also contain other active ingredients, singly or in combination with inert ingredients, designed and incorporated to effect desirable physical and or chemical behavior of the end use formulation. Thus, such formulations may also contain wetting agents, dispersants, emulsifiers, binders, humectants, UV stabilizers, antioxidants, preservatives, thickening agents, suspending agents, viscosity modifying agents, or other fillers.

Compositions of the present invention include both solid and liquid compositions, which are ready for immediate use, and concentrated compositions, which require dilution before use, usually with water.

The solid compositions may be in the form of granules, or dusting powders wherein the active ingredient is mixed with a finely divided solid diluent (e.g. kaolin, bentonite, kiselguhr, dolomite, calcium carbonate, talc, powdered magnesia, Fuller's earth or gypsum). They may also be in the form of dispersible powders of grains, comprising a wetting agent to facilitate the dispersion of the powder or grains in liquid. Solid compositions in the form of a powder may be applied as foliar dusts.

Liquid compositions may comprise a solution, suspension or dispersion of the active ingredients in water or a water-miscible organic solvent, optionally containing a surface-active agent, or may comprise a solution or dispersion of the active ingredient in a water immiscible organic solvent that is dispersed as droplets in water. Preferred ingredients of the composition of the present invention are water-soluble or are readily suspended in water and it is preferred to use aqueous compositions and concentrates.

The compositions of the present invention may contain additional surface-active agents, including for example surface-active agents to increase the compatibility or stability of concentrated compositions as discussed above. Such surface-active agents may be of the cationic, anionic, or non-ionic or amphoteric type or mixtures thereof. The cationic agents are, for example, quaternary ammonium compounds (e.g. cetyltrimethylammonium bromide). Suitable anionic agents are soaps, salts of aliphatic mono esters of sulphuric acid, for example sodium lauryl sulphate; and salts of sulphonated aromatic compounds, for example sodium dodecylbenzenesulphonate, sodium, calcium, and ammonium lignosulphonate, butylnaphthalene sulphonate and a mixture of the sodium salts of diisopropyl and triisopropylnaphthalenesulphonic acid. Suitable non-ionic agents are the condensation products of ethylene oxide with fatty alcohols such as oleyl alcohol and cetyl alcohol, or with alkylphenols such as octyl- or nonyl-phenol or octylcresol. Other non-ionic agents are the partial esters derived from long chain fatty acids and hexitol anhydrides, for example sorbitan monolaurate; the condensation products of the partial ester with ethylene oxide; the lecithins; and silicone surface active agents (water soluble of dispersible surface active agents having a skeleton which comprises a siloxane chain e.g. Silwet L77®). A suitable mixture in mineral oil is ATPLUS 411F®.

Other adjuvants commonly utilized in agricultural compositions include compatibilizing agents, antifoam agents, sequestering agents, neutralizing agents and buffers, corrosion inhibitors, dyes, odorants, spreading agents, penetration aids, sticking agents, dispersing agents, thickening agents, freezing point depressants, antimicrobial agents, and the like. The compositions may also contain other compatible components, for example, plant growth regulants, fungicides, insecticides, and the like and can be formulated with liquid fertilizers or solid, particulate fertilizer carrier such as ammonium nitrate, urea, and the like.

The rate of application of the compositions of the present invention will depend on a number of factors including, the percent active ingredient, the plant species upon which it is used, the growth stage of the plant, the formulation and the method of application, as for example, spraying, addition to irrigation water or other conventional means. As a general guide, however, the application rate of spray solution is from 10 to 5000 liters per hectare, preferably from 100 to 1000 liters per hectare.

Representative plant species that may be treated with the compositions of the present invention include cotton and apples, but it is not intended that the use of the compositions and methods of this invention be limited only to those species.

One utility of this invention is the use of these formulations to improve the activity of foliar applied AVG on crops. Specifically, these formulations would increase AVG activity and may permit more consistent performance, decrease in active ingredient, and/or a greater range in crop effects.

The present invention may be illustrated by the following representative examples:

### EXAMPLES

In all experiments, deionized ultra-pure water was used in preparing solutions. Spray solutions were used as soon as possible after mixing.

### Cotton Cotyledon Bioassay:

A cotton bioassay system has been used in the laboratory to study the effect of formulations on AVG performance. Ten day-old cotton plants (variety SG 105, Delta Pine Land Company, Stoneville, Miss.) with fully expanded cotyledons were used. One spray application of CPPU (forchlorfenuron) is made to the bottom (abaxial) and AVG was subsequently applied to the top (adaxial) surface of the cotyledons. This assay was used as the primary screen for determining if AVG formulations showed superior performance to AVG-HCl.

### Formulations:

All experimental formulations tested were prepared as stock solutions, emulsions and/or suspensions, at a concentration of 100 mM AVG. Water was used as the carrier. Further dilutions were prepared as needed for foliar applications.

AVG is manufactured as the hydrochloride salt (AVG-HCl). In the absence of a designation, AVG is assumed to be AVG-HCl.

All the data was subject to an analysis of variance, and the mean separations were determined with Duncan's new multiple range test at α=0.05. The present invention may be illustrated by the following representative examples:

### Example 1

Formulations containing AVG and other spray adjuvants were tested in the cotton cotyledon assay system described above. Average activity (nl ethylene/gram fresh weight/hour for AVG-HCl divided by nl ethylene/gram fresh weight/hour for an equimolar amount of the formulation of AVG/phenylalanine, AVG-HCl/methionine, AVG-HCl/lecithin, AVG/cetyl phosphate, and AVG/benzoate were 47, 38, 23, 36, and 26% greater, respectively, than an equimolar amount of AVG-HCl (Table 1).

TABLE 1
Activity (ethylene reduction) of AVG
formulations compared with AVG-HCl.

| Treatment | Average activity* | Number of trials |
|---|---|---|
| AVG-HCl | 1.00 | — |
| AVG/phenylalanine | 1.47 | 8 |
| AVG-HCl/methionine | 1.38 | 7 |
| AVG-HCl/lecithin | 1.23 | 8 |
| AVG/cetyl phosphate | 1.36 | 8 |
| AVG/benzoate | 1.26 | 4 |

*Activity was calculated as nl ethylene/gram fresh weight/h for AVG-HCl divided by nl ethylene/gram fresh weight/h for an equimolar amount of the formulation. The activity of AVG-HCl is 1.00. Activities greater than 1.00 indicate formulations more effective than AVG-HCl at reducing ethylene synthesis.

### Example 2

In this Example, 218.5 mg of AVG-HCl was dissolved in 10 mL of de-ionized water. Sodium bicarbonate (88.2 mg) was then added, and the mixture was stirred for 5 minutes until the sodium bicarbonate was dissolved and effervescence subsided. Phenylalanine (165.2 mg) was added and stirred until completely dissolved, resulting in a clear solution.

The reduction in CPPU-induced ethylene production by cotton cotyledons for AVG/phenylalanine was significantly greater than an equimolar amount of AVG-HCl (Table 2).

TABLE 2
Effect of AVG/phenylalanine formulation on the reduction
of CPPU-induced ethylene production by cotton cotyledons.

| | nl | Reduction | |
|---|---|---|---|
| | Ethylene/gram | as compared | |
| | fresh | to CPPU- | |
| Treatment | weight/h | treated | Activity |
| Control | 0.34 | — | — |
| CPPU (200 μM) | 1.11 | 1.00 | — |
| CPPU (200 μM) + | 0.65 | 0.59 | 1.00 |
| AVG-HCl (2 μM) | | | |
| CPPU (200 μM) + | 0.46 | 0.42 | 1.40 |
| AVG/phenylalanine | | | |
| (2 μM) | | | |

n = 6 plants. Mean separation by Duncan's New Multiple Range Test (α = 0.05).

### Example 3

In this Example, 218.5 mg of AVG-HCl was dissolved in 10 mL of de-ionized water. Sodium bicarbonate (88.2 mg) was then added, and the mixture was stirred for 5 minutes until the sodium bicarbonate was dissolved and effervescence subsided. L-methionine (149.2 mg) was added and stirred until completely dissolved, resulting in a clear solution.

The reduction in CPPU-induced ethylene production by cotton cotyledons for AVG-HCl/methionine was numerically greater than an equimolar amount of AVG-HCl (Table 3).

TABLE 3
Effect of AVG HCl/methionine formulation on the reduction
of CPPU-induced ethylene production by cotton cotyledons.

| | nl | Reduction | |
|---|---|---|---|
| | Ethylene/gram | as compared | |
| | fresh | to CPPU- | |
| Treatment | weight/h | treated | Activity |
| Control | 0.37 | — | — |
| CPPU (200 μM) | 1.83 | 1.00 | — |
| CPPU (200 μM) + | 1.23 | 0.67 | 1.00 |
| AVG HCl (2 μM) | | | |
| CPPU (200 μM) + | 0.96 | 0.53 | 1.28 |
| AVG HCl/methionine | | | |
| (2 μM) | | | |

n = 7 plants. Mean separation by Duncan's New Multiple Range Test (α = 0.05).

### Example 4

In this Example, 218.5 mg of AVG-HCl was dissolved in 9.5 mL of de-ionized water. Sodium bicarbonate (88.2 mg) was then added, and the mixture was stirred for 5 minutes until the sodium bicarbonate was dissolved and effervescence subsided. Lecithin (709.7 mg) was added and stirred until completely dissolved, resulting in a clear solution.

The reduction in CPPU-induced ethylene production by cotton cotyledons for AVG-HCl/lecithin was numerically greater than an equimolar amount of AVG-HCl (Table 4).

TABLE 4
Effect of AVG HCl/lecithin formulation on the reduction of
CPPU-induced ethylene production by cotton cotyledons.

| | Nl | Reduction | |
|---|---|---|---|
| | Ethylene/gram | as compared | |
| | fresh | to CPPU- | |
| Treatment | weight/h | treated | Activity |
| Control | 0.60 | — | — |
| CPPU (200 μM) | 2.03 | 1.00 | — |
| CPPU (200 μM) + | 1.11 | 0.55 | 1.00 |
| AVG HCl (2 μM) | | | |
| CPPU (200 μM) + | 0.81 | 0.40 | 1.37 |
| AVG HCl/lecithin | | | |
| (2 μM) | | | |

n = 6 plants. Mean separation by Duncan's New Multiple Range Test (α = 0.05).

### Example 5

In this Example, 218.5 mg of AVG-HCl was dissolved in 8 mL of de-ionized water plus 2 mL of ethylene glycol. 45% potassium hydroxide (130.7 mg) was then added, and the mixture was stirred for 5 minutes. Cetyl phosphate (441.7 mg) was added and stirred for 30 minutes. The resulting suspension was wet-milled until visibly homogeneous.

The reduction in CPPU-induced ethylene production by cotton cotyledons for AVG/cetyl phosphate was numerically greater than an equimolar amount of AVG-HCl (Table 5).

TABLE 5
Effect of AVG/cetyl phosphate formulation on the reduction
of CPPU-induced ethylene production by cotton cotyledons.

| | nl | Reduction | |
|---|---|---|---|
| | Ethylene/gram | as compared | |
| | fresh | to CPPU- | |
| Treatment | weight/h | treated | Activity |
| Control | 0.60 | — | — |
| CPPU (200 μM) | 2.03 | 1.00 | — |
| CPPU (200 μM) + | 1.11 | 0.55 | 1.00 |
| AVG HCl (2 μM) | | | |
| CPPU (200 μM) + | 0.83 | 0.41 | 1.34 |
| AVG/cetyl phosphate | | | |
| (2 μM) | | | |

n = 6 plants. Mean separation by Duncan's New Multiple Range Test (α = 0.05).

### Example 6

In this Example, 218.5 mg of the hydrochloride salt of aminoethoxyvinylglycine (AVG) was dissolved in 10 mL of de-ionized water. Sodium benzoate (144.1 mg) was added and stirred until completely dissolved, resulting in a clear solution.

The reduction in CPPU-induced ethylene production by cotton cotyledons for AVG/sodium benzoate was numerically greater than an equimolar amount of AVG-HCl (Table 6).

TABLE 6
Effect of AVG/sodium benzoate formulation on the reduction
of CPPU-induced ethylene production by cotton cotyledons.

| | nl | Reduction | |
|---|---|---|---|
| | Ethylene/gram | as compared | |
| | fresh | to CPPU- | |
| Treatment | weight/h | treated | Activity |
| Control | 0.38 | — | — |
| CPPU (200 μM) | 0.87 | 1.00 | — |
| CPPU (200 μM) + | 0.61 | 0.70 | 1.00 |
| AVG HCl (2 μM) | | | |
| CPPU (200 μM) + | 0.56 | 0.64 | 1.09 |
| AVG/sodium | | | |
| benzoate (2 μM) | | | |

n = 6 plants. Mean separation by Duncan's New Multiple Range Test (α = 0.05).

### Example 7

Golden Delicious apple fruit were dipped for 1 minute in treatment solutions consisting of 0.025% L-77 or 500 ppm formulated AVG+0.025% Silwet surfactant (an organisilicone wetting agent). Fruit were air dried and held at room temperature for 7 days. At 7 days after treatment, ethylene levels of the internal air space of the fruit were sampled (1.0 ml) from the core by 1.5 inch, 25-gauge needle and syringe. Gas samples were assayed for ethylene on a gas chromatograph equipped with an activated alumina column and a flame ionization detector. Formulations comprising AVG/DL-methionine; AVG/sulfodioctylsuccinic acid, AVG/L-Leucine, and AVG/1-phenylalanine were more effective than the control AVG-HCl (commercial standard) at reducing internal ethylene levels of apple (Table 7).

TABLE 7
Formulation effects on internal ethylene levels of Golden
Delicious apples at 7 days after dip treatment with AVG.

| | Internal ethylene |
|---|---|
| | level 7 days after |
| Treatment | treatment (ppm) |
| “Silwet” surfactant control (0.025%) | 178 |
| (500 ppm AVG•HCl with 0.025% “Silwet”) | 84 |
| (500 ppm AVG/DL-Methionine with 0.025% L-77) | 40 |
| (500 ppm AVG/sulfodioctylsuccinic acid with | 53 |
| 0.025% L-77) | |
| (500 ppm AVG/L-Leucine with 0.025% L-77) | 57 |
| (500 ppm AVG/I-phenylalanine with 0.025% L-77) | 71 |

1. A formulation comprising aminoethoxyvinylglycine and a hydrophobic agent.

2. The formulation as in claim 1 wherein the hydrophobic agent is phenylalanine.

3. The formulation as in claim 1 wherein the hydrophobic agent is methionine.

4. The formulation as in claim 1 wherein the concentration of the aminoethoxyvinylglycine is from 99.999 molar % to 0.001 molar % and the concentration of the hydrophobic agent is from 99.999 molar % to 0.001 molar % of the formulation.

5. The formulation as in claim 1 that is dissolved in water.

6. The formulation as in claim 6 wherein the water is present in an amount from 0.1 wt. % to 99.9 wt. % of the composition.

7. The formulation as in claim 1 wherein the hydrophobic agent is a phospholipid.

8. The formulation as in claim 7 wherein the phospholipid is lecithin.

9. The formulation as in claim 1 wherein the hydrophobic agent is an amphipathic molecule.

10. The formulation as in claim 9 wherein the amphipathic molecule is cetyl phosphate.

11. A method for inhibiting ethylene in a crop plant comprising applying an effective amount of the formulation of claim 1 to the plant.
